(19) United States
(12) Patent Application Publication
(10) Pub. No.: US 2023/0069561 A1
(43) Pub. Date: Mar. 2, 2023

(54) HEATER FOR AEROSOL-FORMING SUBSTRATE COMPRISING A POSITIVE TEMPERATURE COEFFICIENT THERMISTOR

(71) Applicant: Philip Morris Products S.A., Neuchatel (CH)

(72) Inventors: Irene TAURINO, Neuchatel (CH); Ihar Nikolaevich ZINOVIK (Deceased), (US)

(73) Assignee: Philip Morris Products S.A., Neuchatel (CH)

(21) Appl. No.: 17/787,281

(22) PCT Filed: Nov. 18, 2020
(86) PCT No.: PCT/EP2020/082589

§ 371 Date: Jun. 17, 2022

(30) Foreign Application Priority Data
Dec. 20, 2019 (EP) 19218939.7

(51) Int. Cl. A24F 40/57; A24F 40/46; A24F 40/20; A24F 40/51; H05B 6/06; H05B 3/14

(52) U.S. Cl. CPC A24F 40/57; A24F 40/46; A24F 40/20; A24F 40/51; H05B 6/06; H05B 3/141

(57) ABSTRACT

A heater is provided for heating an aerosol-forming substrate, the heater including: a heating element to heat the aerosol-forming substrate, the heating element including at least one positive temperature coefficient (PTC) thermistor, the PTC thermistor being configured to be supplied with an electric current so as to heat the PTC thermistor, in which a resistance of the PTC thermistor increases when a temperature of the PTC thermistor increases within a stabilised temperature range, a lower end of the stabilised temperature range being, when a constant voltage is applied to the PTC thermistor, a reference temperature at which the resistance of the PTC thermistor is twice a value of a minimum resistance of the PTC thermistor, and in which the reference temperature is between about 100° C. and about 350° C. when a constant voltage of 3.3V is applied to the PTC thermistor.

The invention relates to heaters for heating an aerosol-forming substrate and to aerosol-generating devices and aerosol-generating systems comprising such heaters.

Aerosol-generating articles in which an aerosol-forming substrate, such as a tobacco containing substrate, is heated rather than combusted are known in the art. An aim of such heated aerosol-generating articles is to reduce potentially harmful by-products produced by the combustion and pyrolytic degradation of tobacco in conventional cigarettes.

In heated aerosol-generating articles, an inhalable aerosol is typically generated by the transfer of heat from a heater to an aerosol-forming substrate. During heating, volatile compounds are released from the aerosol-forming substrate and become entrained in air. For example, the volatile compounds may become entrained in air drawn through, over, around or otherwise within the vicinity of the aerosol-generating article. As the released volatile compounds cool, they condense to form an aerosol. The aerosol may be inhaled by a user. The aerosol may contain aromas, flavours, nicotine and other desired elements.

The heating element may be comprised in an aerosol-generating device. The combination of an aerosol-generating article and an aerosol-generating device may form an aerosol-generating system.

The heating element may be a resistive heating element that may be inserted into or disposed around the aerosol-forming substrate when the article is received in the aerosol-generating device. However, it might be difficult to adjust the temperature of the resistive heating element in order to provide a desired heating profile, since resistive heating elements might exhibit a slow thermal response. It may be also difficult to avoid potential overheating without providing additional elements.

It would be desirable to provide a heater in which the operating temperature of the heater can be controlled in an efficient manner. It would be also desirable to provide a heater in which the operating temperature of the heater is limited by the configuration of the heater.

A heater for heating an aerosol-forming substrate is provided. The heater may comprise a heating element configured to heat the aerosol-forming substrate. The heating element may comprise at least one positive temperature coefficient (PTC) thermistor. The resistance of the at least one PTC thermistor may increase when the temperature of the at least one PTC thermistor increases within a stabilised temperature range. The lower end of the stabilised temperature range may be a reference temperature at which the resistance of the at least one PTC thermistor is twice the value of a minimum resistance of the at least one PTC thermistor.

In a disclosure, a heater for heating an aerosol-forming substrate is provided, the heater comprising a heating element configured to heat the aerosol-forming substrate, the heating element comprising at least one PTC thermistor, such that the resistance of the at least one PTC thermistor increases when the temperature of the at least one PTC thermistor increases within a stabilised temperature range, the lower end of the stabilised temperature range being a reference temperature at which the resistance of the at least one PTC thermistor is twice the value of a minimum resistance of the at least one PTC thermistor.

The heating element may comprise at least one PTC thermistor. The at least one PTC thermistor is a thermally sensitive resistor which may be heated when an electric current is supplied to the at least one PTC thermistor. When the at least one PTC thermistor is heated, the temperature and the resistance of the at least one PTC thermistor may vary according to a function which relates both parameters. The at least one PTC thermistor may have a good thermal response when the temperature varies according to such function. The operating temperature of the at least one PTC thermistor may therefore be controlled in an efficient manner. In particular, the at least one PTC thermistor may be heated to a temperature which corresponds to a minimum resistance of the at least one PTC thermistor.

Likewise, the at least one PTC thermistor may be heated to a temperature which corresponds to twice the minimum resistance of the at least one PTC thermistor. If the at least one PTC thermistor is heated to a temperature greater than the temperature corresponding to twice the minimum resistance of the at least one PTC thermistor, the resistance of the at least one PTC thermistor increases when the temperature of the at least one PTC thermistor increases within a stabilised temperature range. The stabilised temperature range is therefore delimited by a lower end corresponding to the temperature at which the resistance of the at least one PTC thermistor is twice the value of the minimum resistance of the at least one PTC thermistor. This lower end of the stabilised temperature range is normally referred to as reference temperature of the at least one PTC thermistor. Within the stabilised temperature range, the increase in the resistance of the at least one PTC thermistor when the temperature of the at least one PTC thermistor increases is normally sharp enough to allow for a very slow variation in the temperature of the at least one PTC thermistor. It should be noted that, as used herein, “stabilised temperature range” should be construed as a range of temperatures of a PTC thermistor wherein the temperature is not necessarily constant, even if the variation in the temperature of the PTC thermistor may be negligible with respect to the variation in the resistance of the PTC thermistor.

Therefore, the at least one PTC thermistor may stabilise at substantially the reference temperature (or at a temperature slightly above the reference temperature) within the stabilised temperature range for periods of time that may be longer than the normal operating time of an aerosol-generating device comprising the heater of the present disclosure. This provides for a more consistent heating profile of the aerosol-forming substrate, in which the maximum temperature of the heating element during the operating time can be determined and controlled by providing the appropriate PTC thermistor.

The reference temperature may substantially correspond to the Curie temperature for dielectric PTC thermistors, such as semiconductor ceramics. The Curie temperature is usually defined as a threshold temperature above which certain materials transit from ferroelectricity to paraelectricity.

The heating element comprising at least one PTC thermistor may be less prone to overheating, since the temperature of the at least one PTC thermistor may not significantly exceed the reference temperature. The heater might not need additional dedicated elements to reduce the potentially damaging effects of temperatures above a given temperature threshold by providing PTC thermistor with reference temperatures below such threshold.

The heater might not need a dedicated element, such as a sensor, to measure and regulate the temperature of the heating element, since the reference temperature may be an intrinsic property of the at least one PTC thermistor. Hence, even without such dedicated elements, the heating element may be configured to operate at maximum temperatures which does not substantially exceed the reference temperature of the at least one PTC thermistor.

The heater may comprise an external heating element, the at least one PTC thermistor being comprised in the external heating element. As used herein, the term “external heating element” refers to a heating element configured to heat an outer surface of an aerosol-forming substrate. The external heating element may at least partially circumscribe a cavity for receiving the aerosol-forming substrate.

The heater may comprise an internal heating element, the at least one PTC thermistor being comprised in the internal heating element. As used herein, the term “internal heating element” refers to a heating element configured to be inserted into an aerosol-forming substrate. The internal heating element may be in the form of a blade, a pin, and a cone. The internal heating element may extend into a cavity for receiving the aerosol-forming substrate.

In some embodiments, the heater comprises an internal heating element and an external heating element.

The heater is configured to heat an aerosol-forming substrate.

As used herein, the term “aerosol-forming substrate” relates to a substrate capable of releasing volatile compounds that can form an aerosol. Such volatile compounds may be released by heating the aerosol-forming substrate. An aerosol-forming substrate is typically part of an aerosol-generating article.

The aerosol-forming substrate may comprise nicotine. The nicotine-containing aerosol-forming substrate may be a nicotine salt matrix.

The aerosol-forming substrate may be a liquid. The aerosol-forming substrate may comprise solid components and liquid components. Preferably, the aerosol-forming substrate is a solid.

The aerosol-forming substrate may comprise plant-based material. The aerosol-forming substrate may comprise tobacco. The aerosol-forming substrate may comprise a tobacco-containing material including volatile tobacco flavour compounds which are released from the aerosol-forming substrate upon heating. The aerosol-forming substrate may comprise a non-tobacco material. The aerosol-forming substrate may comprise homogenised plant-based material. The aerosol-forming substrate may comprise homogenised tobacco material. Homogenised tobacco material may be formed by agglomerating particulate tobacco. In a particularly preferred embodiment, the aerosol-forming substrate comprises a gathered crimped sheet of homogenised tobacco material. As used herein, the term “crimped sheet” denotes a sheet having a plurality of substantially parallel ridges or corrugations.

The aerosol-forming substrate may comprise at least one aerosol-former. An aerosol-former is any suitable known compound or mixture of compounds that, in use, facilitates formation of a dense and stable aerosol and that is substantially resistant to thermal degradation at the temperature of operation of the system. Suitable aerosol-formers are well known in the art and include, but are not limited to: polyhydric alcohols, such as triethylene glycol, 1,3-butanediol and glycerine; esters of polyhydric alcohols, such as glycerol mono-, di- or triacetate; and aliphatic esters of mono-, di- or polycarboxylic acids, such as dimethyl dodecanedioate and dimethyl tetradecanedioate. Preferred aerosol formers may include polyhydric alcohols or mixtures thereof, such as triethylene glycol, 1,3-butanediol. Preferably, the aerosol former is glycerine. Where present, the homogenised tobacco material may have an aerosol-former content of equal to or greater than about 5 percent by weight on a dry weight basis, such as between about 5 percent and about 30 percent by weight on a dry weight basis. The aerosol-forming substrate may comprise other additives and ingredients, such as flavourants.

The reference temperature of the at least one PTC thermistor may be between about 100 degrees Celsius and about 350 degrees Celsius when a constant voltage of 3.3 Volts is applied to the at least one PTC thermistor.

This range of reference temperatures may be beneficial to heat the aerosol-forming substrate sufficiently to release certain substances that may be comprised in the aerosol-forming substrate, such as nicotine or processed tobacco leaves.

More preferably, the reference temperature of the at least one PTC thermistor may be between about 200 degrees Celsius and about 250 degrees Celsius.

This range of reference temperatures may adequate to heat the aerosol-forming substrate sufficiently to release certain substances that may be comprised in the aerosol-forming substrate, such as nicotine-containing e-liquids and gel-like substances.

The heating element may be configured to be inserted into the aerosol-forming substrate.

Put another way, the heating element may be an internal heating element. The internal heating element may pierce the aerosol-forming substrate. The internal heating element may also be received in an inner cavity of the aerosol-forming substrate. The heater may comprise a cavity for receiving the aerosol-forming substrate when the internal heating element is inserted into the aerosol-forming substrate. When electric current is supplied to the internal heating element, the temperature of the internal heating element rises until it reaches the reference temperature of the at least one PTC thermistor comprised in the internal heating element. If the supply of electric current is maintained after this instant, the temperature of the internal heating element stabilises at temperature which substantially corresponds to the reference temperature of the at least one PTC thermistor comprised in the internal heating element. Thus, the internal heating element may be used to heat the aerosol-forming substrate at substantially the reference temperature of the at least one PTC thermistor. The reference temperature may be tuned to optimise the release of volatile compounds from the substrate.

The heating element may be configured to heat an outer surface of the aerosol-forming substrate.

Put another way, the heating element may be an external heating element. The external heating element may comprise a cavity for receiving the aerosol-forming substrate. The cavity may comprise an inner wall configured to be in thermal contact with the outer surface of the aerosol-forming substrate. When electric current is supplied to the external heating element, the temperature of the external heating element rises until it reaches the reference temperature of the at least one PTC thermistor comprised in the external heating element. If the supply of electric current is maintained after this instant, the temperature of the external heating element stabilises at temperature which substantially corresponds to the reference temperature of the at least one PTC thermistor comprised in the external heating element. Thus, the external heating element may be used to heat the aerosol-forming substrate at substantially the reference temperature of the at least one PTC thermistor. The reference temperature may be tuned to optimise the release of volatile compounds from the substrate.

The heater may comprise a heater housing, the heater housing comprising a peripheral portion extending in the transversal direction between a peripheral inner wall and a peripheral outer wall, and a bottom portion extending in the longitudinal direction between a bottom inner wall and a bottom outer wall; a cavity for receiving the aerosol-forming substrate extending longitudinally between an open end and the bottom inner wall, the cavity being delimited in the transversal direction by the peripheral inner wall.

The peripheral inner wall and the bottom inner wall may have the appropriate dimensions and shape to define the cavity for receiving the aerosol-forming substrate in such a way that the transfer of heat from the heating element to the aerosol-forming substrate may be optimised.

The at least one PTC thermistor may be a PTC disk arranged within the bottom portion.

This may allow for a heater which is easy to manufacture and assemble while providing a satisfactory heating profile to the aerosol-forming substrate when the substrate is received in the cavity of the heater housing. In this embodiment, the temperature of the peripheral inner wall may not differ considerably from the temperature of the PTC disk. Hence, an appropriate transfer of heat between the PTC disk and the aerosol-forming substrate may be achieved.

The at least one PTC thermistor may comprise a PTC tube arranged within the peripheral portion so as to circumscribe the peripheral inner wall.

In this arrangement, the temperature of the peripheral inner wall may be substantially the same as the temperature of the PTC tube. This may lead to an enhanced transfer of heat between the PTC tube and the aerosol-forming substrate.

The peripheral outer wall may comprise at least three planar sections, the at least one PTC thermistor comprising at least one PTC plate arranged on at least one of the at least three planar sections.

The provision of at least three planar sections on the peripheral outer wall may be advantageous in that at least one PTC plate, which may be easy to manufacture, may be disposed on the flat surface of one or more of the at least three planar sections. This arrangement may give rise to an optimised transfer of heat from the at least one PTC plate to the aerosol-forming substrate when the substrate is received in the cavity of the heater housing. The PTC plates are planar.

The peripheral outer wall may define, according to a cross section, a regular or an irregular polygon. In an example, the polygon is one of a triangle, a rectangle, a square, a pentagon and an hexagon.

The at least one PTC thermistor may comprise at least three PTC plates, such that each of the at least three PTC plates is arranged on a different planar section, the number of PTC plates being equal to the number of planar sections.

In this embodiment, a PTC plate is arranged on each planar section. This may contribute to improving the transfer of heat from the PTC plates to the aerosol-forming substrate when the substrate is received in the cavity of the heater housing.

At least two of the at least three PTC plates may have a different reference temperature.

This may be helpful to heat different sections of the aerosol-forming substrate, when the substrate is received in the cavity of the heater housing, to different temperatures. This may be used to provide a sequential heating of the different sections of the aerosol-forming substrate, which may help reduce the mass of evaporated aerosol that may occur due to the depletion of the substrate in contact with the heater housing.

The at least three PTC plates may be electrically connected in parallel to one another.

This may reduce the overall electrical resistance of the heater, thus increasing power dissipation when batteries of small size are used, such as batteries with a voltage between 3.0 Volts and 6.0 Volts.

The peripheral outer wall may comprise six planar sections.

It has been found that the arrangement with six planar sections may lead to a compromise between an optimal transfer of heat between from the PTC plates to the aerosol-forming substrate when the substrate is received in the cavity of the heater housing and the ease of manufacture of the planar sections.

The heater housing may comprise an electrically conductive material, such as an electrically conductive metal, the heater housing forming a first electrode in electrical contact with the at least one PTC plate. The heater may further comprise at least one external electrical contact comprising an electrically conductive material, such as an electrically conductive metal, and forming a second electrode in electrical contact with the at least one PTC plate.

By using the heater housing as first electrode for the at least one PTC plate, the supply of electric current may be integrated in the heater in a more compact manner. The electrically conductive material comprised in the housing may be a metal, such as aluminium.

Likewise, the at least one external electrical contact is advantageous in that it may allow for an easy-to-assemble arrangement for the supply of electric current.

In the embodiment in which the PTC thermistor comprises at least three PTC plates, such that each of the at least three PTC plates is arranged on a different planar section, at least three external electrical contacts may be provided, each external electrical contact being in electrical contact with a different PTC plate. This arrangement may enable an appropriate supply of electric current to the at least three PTC plates. In particular, in the embodiment comprising six PTC plates, and therefore six external electrical contacts, it may be possible to reach a temperature substantially equal to the reference temperature of each PTC plate in 30 seconds.

In an embodiment, the at least one PTC plate may have a length of about 7 millimetres. The at least one PTC plate may have a width of about 3.8 millimetres. The at least one PTC plate may have a thickness of about 0.5 millimetres.

The at least one PTC thermistor may comprise a ceramic semiconductor, such as barium titanate.

The provision of the appropriate ceramic semiconductor may allow for an adjustment of the reference temperature of the at least one PTC thermistor. When the at least one PTC thermistor is made of a ceramic semiconductor, the reference temperature of the PTC semiconductor may substantially correspond to the Curie temperature of the ceramic semiconductor.

The at least one PTC thermistor may comprise a polymeric material.

The provision of a polymeric material may be advantageous in that it may enable a simplified assembly of the at least one PTC thermistor in the heater, due to the high flexibility that some polymeric materials may possess. This may also lead to less fragile heaters. This may also produce heaters having a lower thermal mass, which may result in lower thermal latency during heating.

The polymeric material may comprise polyethylene. The polymeric material may comprise carbon grains, carbon ink or other suitable conductive grains. The carbon grains may comprise carbon black. The carbon grains may comprise nickel powder.

The polymeric material may comprise a polymer film.

The heater may comprise a laminated backing which may be directly attached to the polymeric film. The laminated backing may comprise a metal, such as copper.

The at least one PTC thermistor may comprise a blend of barium titanate and an alkali earth metal element, such as strontium or bismuth element. The at least one PTC thermistor may comprise a blend of barium titanate and lead titanate. These blends may allow for an additional adjustment of the reference temperature of the at least one PTC thermistor.

Further additives may be added to the at least one PTC thermistor so as to tune the reference temperature of the at least one PTC thermistor to the desired level.

In a disclosure, an aerosol-generating device comprising any of the heaters disclosed above is provided. As used herein, the term “aerosol-generating device” refers to a device that interacts with an aerosol-forming substrate to generate an aerosol.

Since the aerosol-generating device of this disclosure comprises a heater according to the previous disclosures, the advantages specified above for the heaters also apply to the device itself.

The aerosol-generating device may comprise a device housing. The device housing may at least partially define a cavity for receiving the aerosol-forming substrate. Preferably the cavity for receiving an aerosol-forming substrate is at a proximal end of the device.

The device housing may be elongate. Preferably, the device housing is cylindrical in shape. The device housing may comprise any suitable material or combination of materials. Examples of suitable materials include metals, alloys, plastics or composite materials containing one or more of those materials, or thermoplastics that are suitable for food or pharmaceutical applications, for example polypropylene, polyetheretherketone (PEEK) and polyethylene. Preferably, the material is light and non-brittle.

Preferably, the aerosol-generating device is portable. The aerosol-generating device may have a size comparable to a conventional cigar or cigarette. The aerosol-generating device may have a total length between about 30 millimetres and about 150 millimetres. The aerosol-generating device may have an external diameter between about 5 millimetres and about 30 millimetres. The aerosol-generating device may be a handheld device. In other words, the aerosol-generating device may be sized and shaped to be held in the hand of a user.

The aerosol-generating device may comprise a power supply configured to supply an electric current to the heating element.

The power supply may be a DC power supply. In preferred embodiments, the power supply is a battery. The power supply may be a nickel-metal hydride battery, a nickel cadmium battery, or a lithium based battery, for example a lithium-cobalt, a lithium-iron-phosphate or a lithium-polymer battery. However, in some embodiments the power supply may be another form of charge storage device, such as a capacitor. The power supply may require recharging and may have a capacity that allows for the storage of enough energy for one or more user operations. For example, the power supply may have sufficient capacity to allow for continuous heating of an aerosol-forming substrate for a period of around six minutes, corresponding to the typical time taken to smoke a conventional cigarette, or for a period that is a multiple of six minutes. In another example, the power supply may have sufficient capacity to allow for a predetermined number of puffs or discrete activations of the aerosol generator. In another example, the power supply may have sufficient capacity to allow for a predetermined number of uses of the device or discrete activations. In one embodiment, the power supply is a DC power supply having a DC supply voltage in the range of about 2.5 Volts to about 4.5 Volts and a DC supply current in the range of about 1 Amp to about 10 Amps (corresponding to a DC power supply in the range of about 2.5 Watts to about 45 Watts).

The aerosol-generating device may comprise a controller connected to the heating element and the power supply. The controller may be configured to control the supply of power to the heating element from the power supply. The controller may comprise a microprocessor, which may be a programmable microprocessor, a microcontroller, or an application specific integrated chip (ASIC) or other electronic circuitry capable of providing control. The controller may comprise further electronic components. The controller may be configured to regulate a supply of current to the heating element. Current may be supplied to the heating element continuously following activation of the aerosol-generating device or may be supplied intermittently, such as on a puff by puff basis.

The controller may advantageously comprise DC/AC inverter, which may comprise a Class-D or Class-E power amplifier.

In some embodiments, the device housing comprises a mouthpiece. The mouthpiece may comprise at least one air inlet and at least one air outlet. The mouthpiece may comprise more than one air inlet. The one or more of the air inlets may reduce the temperature of the aerosol before it is delivered to a user and may reduce the concentration of the aerosol before it is delivered to a user.

In some embodiments, a mouthpiece is provided as part of an aerosol-generating article. As used herein, the term “mouthpiece” refers to a portion of an aerosol-generating system that is placed into a user's mouth in order to directly inhale an aerosol generated by the aerosol-generating system from an aerosol-generating article received by the aerosol-generating device.

The aerosol-generating device may include a user interface to activate the device, for example a button to initiate heating of an aerosol-generating article.

The aerosol-generating device may comprise a display to indicate a state of the device or of the aerosol-forming substrate.

In a disclosure, an aerosol-generating system comprising any of the above aerosol-generating devices is provided. The aerosol-generating system further comprises an aerosol-generating article comprising the aerosol-forming substrate.

As used herein, the term “aerosol-generating article” refers to an article comprising an aerosol-forming substrate that is capable of releasing volatile compounds that can form an aerosol. For example, an aerosol-generating article may be an article that generates an aerosol that is directly inhalable by the user drawing or puffing on a mouthpiece at a proximal or user-end of the system. The aerosol-generating article may be disposable.

As used herein, the term “aerosol-generating system” refers to the combination of an aerosol-generating device with an aerosol-generating article. In the aerosol-generating system, the aerosol-generating article and the aerosol-generating device cooperate to generate a respirable aerosol.

Since the aerosol-generating system of this disclosure comprises a heater according to the previous disclosures, the advantages specified above for the heaters also apply to the system itself.

The aerosol-generating article may have any suitable form. The aerosol-generating article may be substantially cylindrical in shape. The aerosol-generating article may be substantially elongate. The aerosol-generating article may have a length and a circumference substantially perpendicular to the length.

The aerosol-forming substrate may be provided as an aerosol-generating segment containing an aerosol-forming substrate. The aerosol-generating segment may comprise a plurality of aerosol-forming substrates. The aerosol-generating segment may comprise a first aerosol-forming substrate and a second aerosol-forming substrate. In some embodiments, the second aerosol-forming substrate is substantially identical to the first aerosol-forming substrate. In some embodiments, the second aerosol-forming substrate is different from the first aerosol-forming substrate.

The aerosol-generating segment may be substantially cylindrical in shape. The aerosol-generating segment may be substantially elongate. The aerosol-generating segment may also have a length and a circumference substantially perpendicular to the length.

Where the aerosol-generating segment comprises a plurality of aerosol-forming substrates, the aerosol-forming substrates may be arranged end-to-end along an axis of the aerosol-generating segment. In some embodiments, the aerosol-generating segment may comprise a separation between adjacent aerosol-forming substrates.

In some preferred embodiments, the aerosol-generating article may have a total length between about 30 millimetres and about 100 millimetres. In some embodiments, the aerosol-generating article has a total length of about 45 millimetres. The aerosol-generating article may have an outer diameter between about 5 millimetres and about 12 millimetres. In some embodiments, the aerosol-generating article may have an outer diameter of about 7.2 millimetres.

The aerosol-generating segment may have a length of between about 7 millimetres and about 15 millimetres. In some embodiments, the aerosol-generating segment may have a length of about 10 millimetres, or 12 millimetres.

The aerosol-generating segment preferably has an outer diameter that is about equal to the outer diameter of the aerosol-generating article. The outer diameter of the aerosol-generating segment may be between about 5 millimetres and about 12 millimetres. In one embodiment, the aerosol-generating segment may have an outer diameter of about 7.2 millimetres.

The aerosol-generating article may comprise a filter plug. The filter plug may be located at a proximal end of the aerosol-generating article. The filter plug may be a cellulose acetate filter plug. In some embodiments, the filter plug may have a length of about 5 millimetres to about 10 millimetres. In some preferred embodiments, the filter plug may have a length of about 7 millimetres.

The aerosol-generating article may comprise an outer wrapper. The outer wrapper may be formed from paper. The outer wrapper may be gas permeable at the aerosol-generating segment. In particular, in embodiments comprising a plurality of aerosol-forming substrates, the outer wrapper may comprise perforations or other air inlets at the interface between adjacent aerosol-forming substrates. Where a separation is provided between adjacent aerosol-forming substrates, the outer wrapper may comprise perforations or other air inlets at the separation. This may enable an aerosol-forming substrate to be directly provided with air that has not been drawn through another aerosol-forming substrate. This may increase the amount of air received by each aerosol-forming substrate. This may improve the characteristics of the aerosol generated from the aerosol-forming substrate.

The aerosol-generating article may also comprise a separation between the aerosol-forming substrate and the filter plug. The separation may be about 18 millimetres, but may be in the range of about 5 millimetres to about 25 millimetres.

In a disclosure, a method of operating any of the above aerosol-generating systems is provided. The method may comprise the step of determining a maximum operating temperature for the aerosol-forming substrate comprised in the aerosol-generating article. The method may comprise the step of supplying an electric current to the at least one PTC thermistor, by means of the power supply, the electric current having a constant voltage. The constant voltage may be such that the reference temperature of the PTC thermistor is substantially the maximum operating temperature for the aerosol-forming substrate.

In this disclosure, a method of operating any of the above aerosol-generating systems is provided, the method comprising the steps of:
determining a maximum operating temperature for the aerosol-forming substrate comprised in the aerosol-generating article;
supplying an electric current to the at least one PTC thermistor, by means of the power supply, the electric current having a constant voltage, the constant voltage being such that the reference temperature of the PTC thermistor is substantially the maximum operating temperature for the aerosol-forming substrate.

These steps may be controlled by a controller. The aerosol-generating device may comprise the controller. Alternatively, the controller may be provided in a device external to the aerosol-generating system, such as a computer or a mobile phone. The controller may be configured to detect the type of aerosol-forming substrate in the aerosol-generating system. The controller may store a maximum operating temperature for each type of aerosol-forming substrate, in order to enhance the formation of aerosol when the aerosol-forming substrate is heated. The controller may be configured to receive external data to determine the maximum operating temperature for the aerosol-forming substrate. The controller may use any other suitable configuration to determine the maximum operating temperature for the aerosol-forming substrate.

The resistance of the at least one PTC thermistor may depend on the grain resistance and on the grain boundary transition resistance of the grains forming the material comprised in the at least one PTC thermistor. The higher the voltage applied to the at least one PTC thermistor is, the lower the resistance of the at least one PTC thermistor may be. The decrease in the resistance of the at least one PTC thermistor with increased voltage may be more significant when the temperature is greater than the reference temperature of the at least one PTC thermistor, since a break-up of the barriers between grains may be more likely to happen; likewise, a proportion of the applied voltage might not be absorbed by the grain resistance. However, it has been found out that the decrease in the resistance of the at least one PTC thermistor with increased voltage may be noticeable at the reference temperature or at temperatures below the reference temperature of the at least one PTC thermistor. Due to this effect, it has been found out that the reference temperature of the at least one PTC thermistor may be dependent on the voltage applied to the at least one PTC thermistor.

The method of the present disclosure may advantageously take advantage of the variation of the reference temperature of the at least one PTC thermistor with the voltage applied to the at least one PTC thermistor. To achieve so, the controller may control the power supply to supply an electric current to the at least one PTC thermistor having a constant voltage. The chosen constant voltage may be determined by the controller to ensure that the reference temperature of the PTC thermistor is substantially the maximum operating temperature for the aerosol-forming substrate. The controller may store a table which associates the voltage applied to the at least one PTC thermistor to the reference temperature of the at least one PTC thermistor.

The method of the present disclosure may therefore allow the at least one PTC thermistor of the aerosol-generating system to substantially stabilise at the maximum operating temperature for the aerosol-forming substrate. The temperature at which the at least one PTC thermistor stabilises is substantially the same as, or sufficiently close to, the temperature applied to the aerosol-forming substrate when the aerosol-generating system is in use to heat the aerosol-forming substrate. Therefore, the temperature at which the PTC thermistor stabilises may be chosen to optimise the formation of aerosol. This may be beneficial to provide an optimised aerosol experience.

In a disclosure, a method of operating any of the above aerosol-generating systems is provided. The method may comprise the step of measuring puff intensity when a puff is drawn during use of the aerosol-generating system. The method may comprise the step of determining a puff intensity threshold. When the puff intensity is equal to or above the puff intensity threshold, the method may comprise the step of determining a first maximum operating temperature and a second maximum operating temperature for the aerosol-forming substrate comprised in the aerosol-generating article. The method may comprise the step of selecting the first maximum operating temperature or the second maximum operating temperature. If the first maximum operating temperature is selected, the method may comprise the step of supplying an electric current to the at least one PTC thermistor, by means of the power supply, the electric current having a first constant voltage, the first constant voltage being such that the reference temperature of the PTC thermistor is substantially the first maximum operating temperature for the aerosol-forming substrate. If the second maximum operating temperature is selected, the method may comprise the step of supplying an electric current to the at least one PTC thermistor, by means of the power supply, the electric current having a second constant voltage, the second constant voltage being such that the reference temperature of the PTC thermistor is substantially the second maximum operating temperature for the aerosol-forming substrate.

In this disclosure, a method of operating any of the above aerosol-generating systems is provided, the method comprising the steps of:
measuring puff intensity when a puff is drawn during use of the aerosol-generating system;
determining a puff intensity threshold, such that, when the puff intensity is equal to or above the puff intensity threshold, the method comprises the additional steps of:
   determining a first maximum operating temperature and a second maximum operating temperature for the aerosol-forming substrate comprised in the aerosol-generating article;
   selecting the first maximum operating temperature or the second maximum operating temperature;
   if the first maximum operating temperature is selected, supplying an electric current to the at least one PTC thermistor, by means of the power supply, the electric current having a first constant voltage, the first constant voltage being such that the reference temperature of the PTC thermistor is substantially the first maximum operating temperature for the aerosol-forming substrate;
   if the second maximum operating temperature is selected, supplying an electric current to the at least one PTC thermistor, by means of the power supply, the electric current having a second constant voltage, the second constant voltage being such that the reference temperature of the PTC thermistor is substantially the second maximum operating temperature for the aerosol-forming substrate.

As explained for the method of the previous disclosure, a variation in the reference temperature of the at least one PTC thermistor may be achieved by varying the voltage applied to the at least one PTC thermistor. This may allow for an adjustment of the reference temperature to substantially correspond to the maximum operating temperature for the aerosol-forming substrate, thus optimising the formation of aerosol.

For some aerosol-forming substrates, it may be advantageous to vary the maximum operating temperature. This may enable to adapt the formation of aerosol to a given aerosol experience. Such aerosol experience may be chosen according to the preferences of a user of the aerosol-generating system.

However, as indicated for the method of the previous disclosure, the variation in the reference temperature of the at least one PTC thermistor by varying the voltage applied to the at least one PTC thermistor may be relatively small. Put another way, the methods of the present disclosure may normally enable for a variation in the reference temperature of the at least one PTC thermistor within a small range of temperatures.

The method of the present disclosure comprises the step of measuring puff intensity when a puff is drawn during use of the aerosol-generating system. The method also comprises the step of determining a puff intensity threshold. These steps may also be performed by the controller.

The controller may be configured to determine the reference temperature of the at least one PTC thermistor, by determining the voltage applied to the at least one PTC thermistor, only when the puff intensity is equal to or greater than the puff intensity threshold. When the puff intensity is lower than the puff intensity threshold, the temperature of the at least one PTC thermistor may normally be a function of puff intensity. The function may be stored in the controller.

When the puff intensity is equal to or greater than the puff intensity threshold, the controller may adjust the voltage applied to the at least one PTC thermistor to determine the reference temperature of the at least one PTC thermistor. The controller may control the power supply to supply a first constant voltage to the at least one PTC thermistor; the first constant voltage leads to a first reference temperature of the at least one PTC thermistor. The controller may control the power supply to supply a second constant voltage, different to the first constant voltage, to the at least one PTC thermistor; the second constant voltage leads to a second reference temperature of the at least one PTC thermistor. Preferably, the first reference temperature and the second reference temperature are equal to or greater than the temperature corresponding to the threshold puff intensity in the function relating the temperature of the at least one PTC thermistor and the puff intensity.

By limiting the adjustment of the reference temperature of the at least one PTC thermistor to puff intensities equal to or greater than the puff intensity threshold, the specific range of reference temperatures that may be achieved by varying the voltage supplied to the at least one PTC thermistor is focused on the temperatures that may lead to overheating of the aerosol-generating device or to the production of lesser quality aerosols. Within such specific range, even if the variation in the reference temperature of the at least one PTC thermistor may be relatively small, the corresponding variation in the maximum operating temperature of the aerosol-forming substrate may advantageously allow for a substantial variation of the properties of the formed aerosol, thus enabling an aerosol experience that may be optimised or customised. The controller may select the first reference temperature or the second reference temperature to achieve the desired properties in the formed aerosol.

Likewise, since the first reference temperature and the second reference temperature of the PTC thermistor may be equal to or greater than the temperature corresponding to the puff intensity threshold in the function relating the temperature of the at least one PTC thermistor and the puff intensity, the aerosol-generating system comprising the at least one PTC thermistor may be configured to modify the temperature of the at least one PTC thermistor according to such function, without reaching an stabilised temperature range, when a puff having an intensity below the puff intensity threshold is drawn.

The method of the present disclosure may also allow for a determination and a selection of further reference temperatures, such as a third reference temperature, a fourth reference temperature, a fifth reference temperature, a seventh reference temperature, an eighth reference temperature, a ninth reference temperature, a tenth reference temperature or any other reference temperature.

Although the methods of the above disclosures comprise the steps of providing a constant voltage, the controller may also be configured to control the power supply so as to use pulse width modulation or pulse frequency modulation when the electric current is supplied to the at least one PTC thermistor. In such cases, the resulting methods are identical to the methods of the above disclosures except in that it is respectively the pulse width or the pulse frequency that are associated to a given reference temperature of the at least one PTC thermistor. Therefore, the reference temperature of the at least one PTC thermistor may be adjusted by adjusting the pulse width or the pulse frequency of the electric current supplied to the at least one PTC thermistor.

These and other features and advantages of the invention will become more evident in the light of the following detailed description of preferred embodiments, given only by way of illustrative and non-limiting example, in reference to the attached figures:

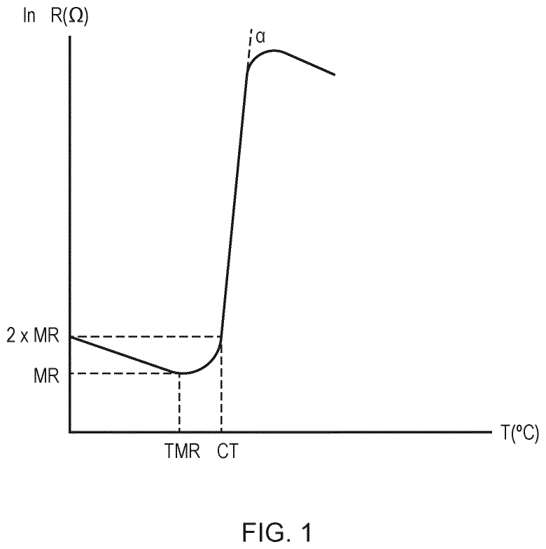

FIG. 1 shows a temperature/resistance graphic of a PTC thermistor comprised in a heating element.

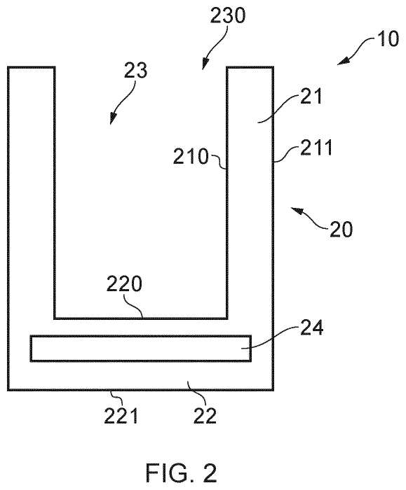

FIG. 2 illustrates a longitudinal section of a heater comprising a heater housing and a PTC disk.

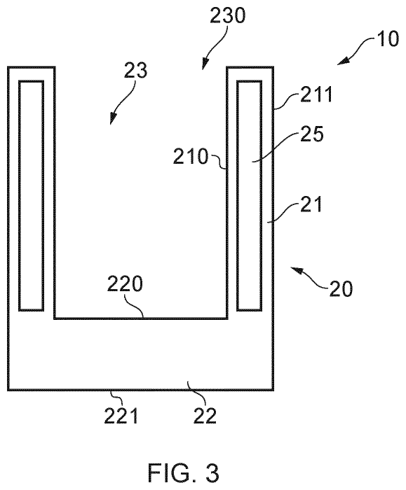

FIG. 3 depicts a longitudinal section of a heater comprising a heater housing and a PTC tube.

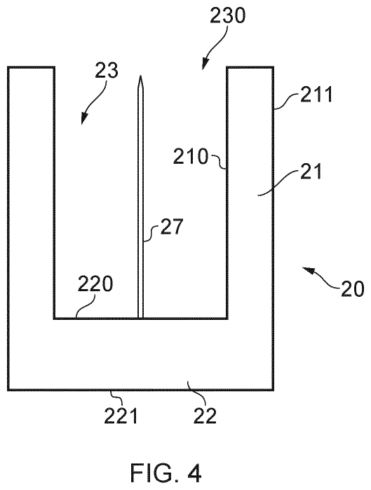

FIG. 4 represents a longitudinal section of a heater comprising a heater housing and an internal heating element.

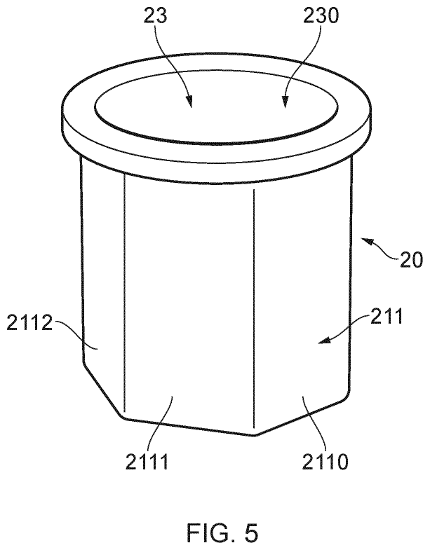

FIG. 5 shows a perspective view of a heater housing which in turn comprises six planar sections.

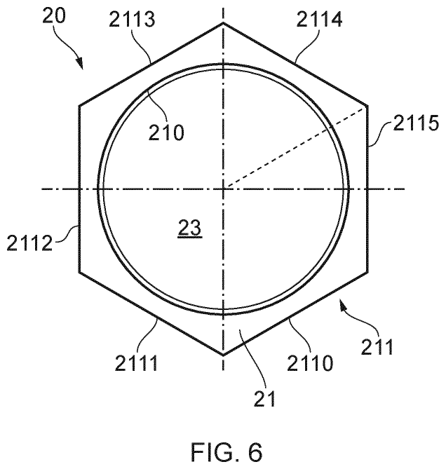

FIG. 6 depicts a cross section of the heater housing of FIG. 5.

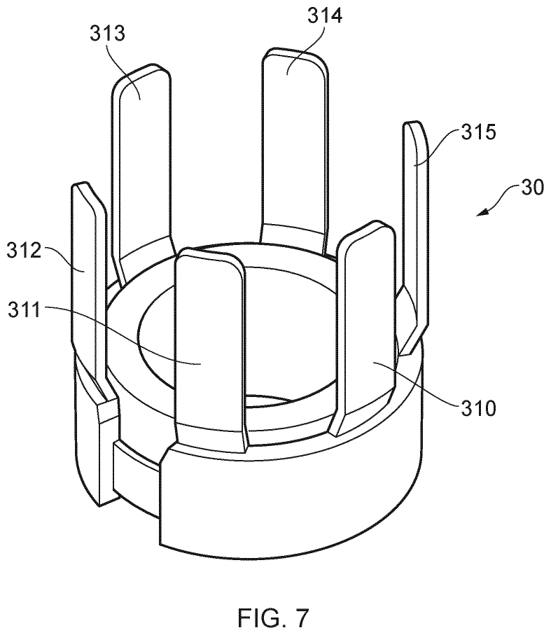

FIG. 7 is a representation of plurality of external electrical contacts.

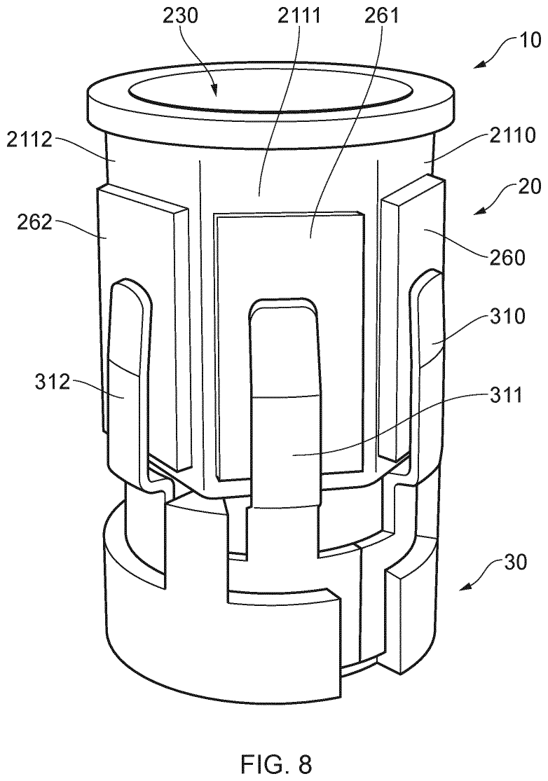

FIG. 8 illustrates a perspective view of a heater comprising the heater housing of FIG. 5 and the plurality of external electrical contacts of FIG. 7.

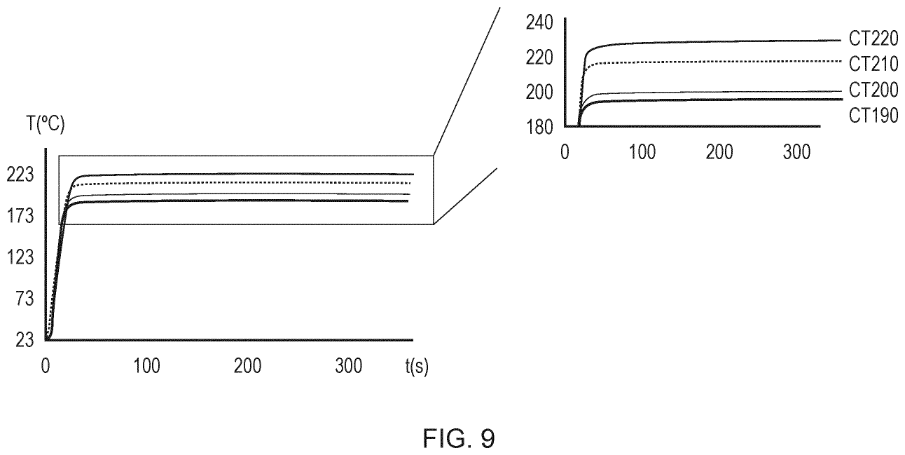

FIG. 9 represents the temperature of a peripheral inner wall for four examples of the heater of FIG. 8.

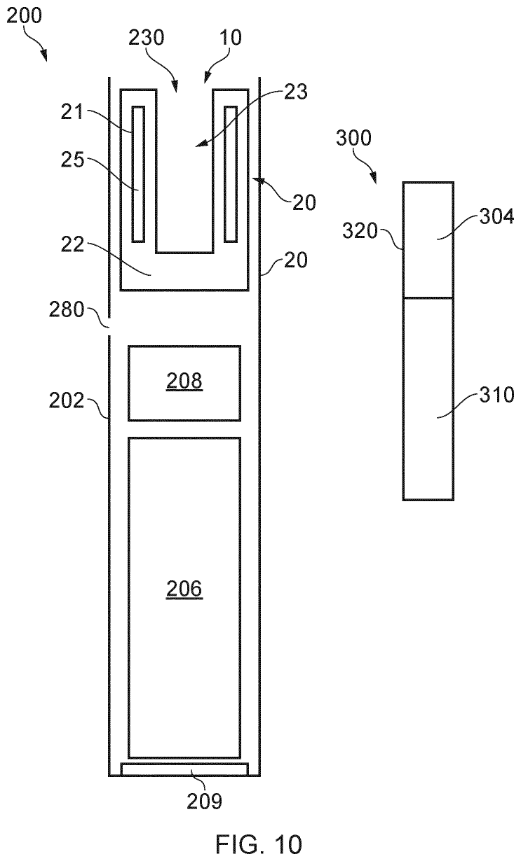

FIG. 10 depicts an aerosol-generating system comprising an aerosol-generating article and an aerosol-generating device which in turn comprises the heater of FIG. 3.

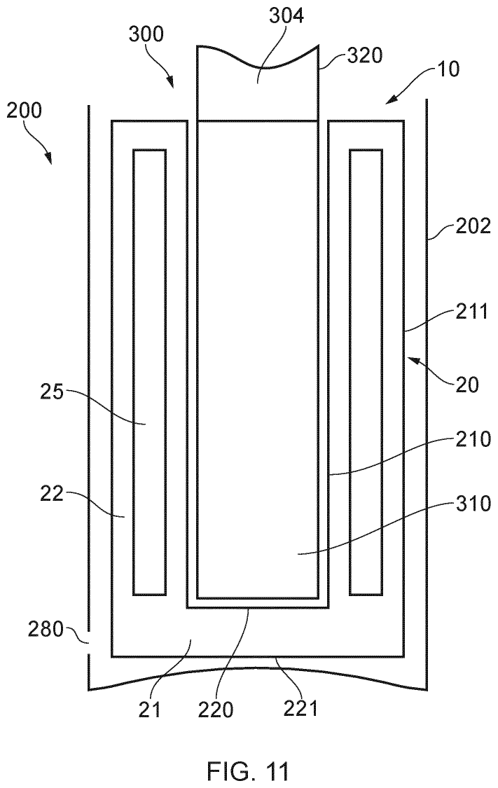

FIG. 11 shows the aerosol-generating system of FIG. 10, in which the aerosol-generating-article is received in the cavity of the heater housing.

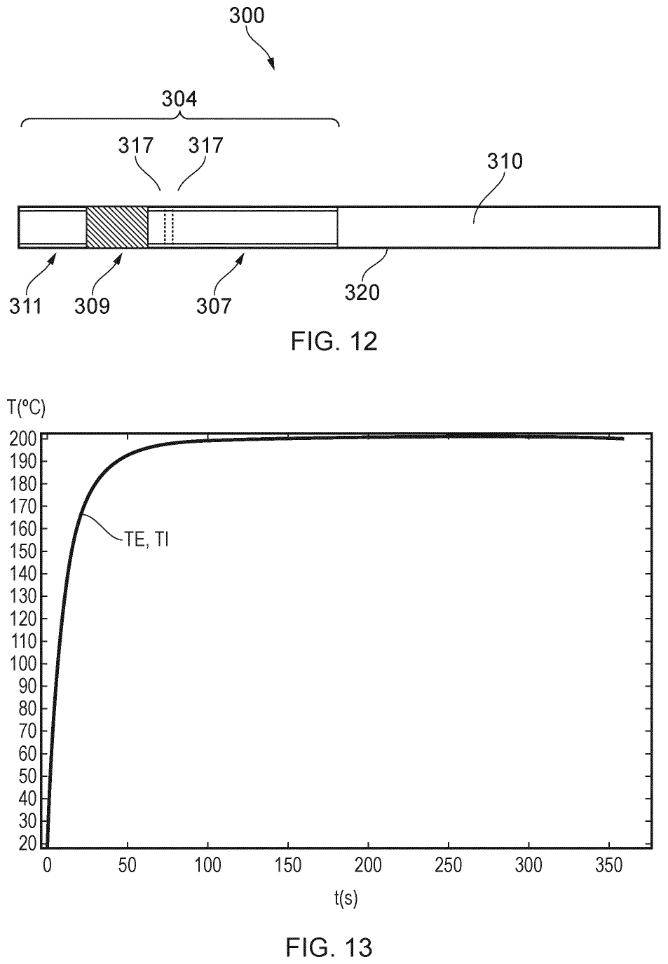

FIG. 12 illustrates an embodiment of aerosol-generating article.

FIG. 13 represents the evolution of the temperature of the peripheral inner wall and the temperature of the PTC tube for the heater of FIG. 3.

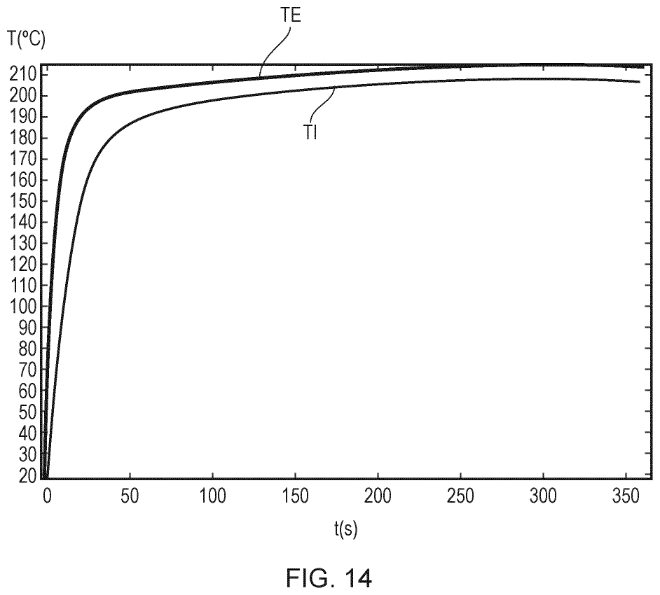

FIG. 14 depicts the evolution of the temperature of the peripheral inner wall and the temperature of the PTC disk for the heater of FIG. 2.

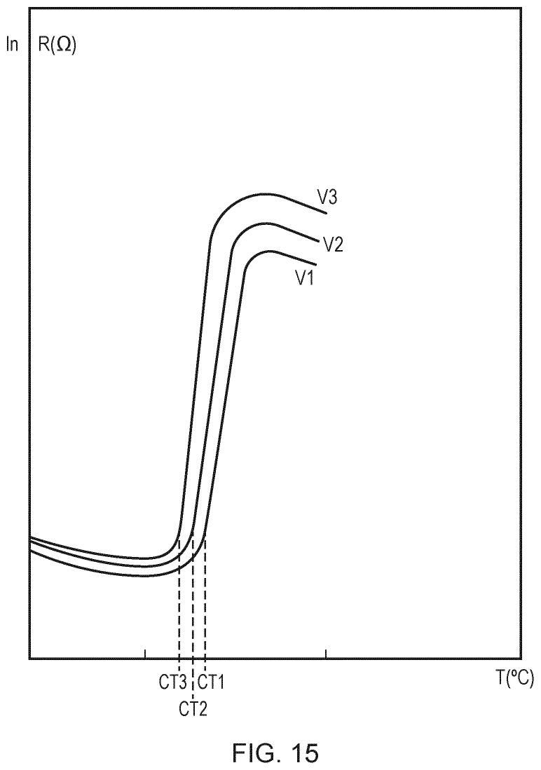

FIG. 15 shows three temperature/resistance graphics of a PTC thermistor comprised in a heating element when three different constant voltages are applied to the PTC thermistor.

FIG. 1 shows a temperature T/resistance R graphic of a PTC thermistor comprised in a heating element of a heater for heating an aerosol-forming substrate.

The PTC thermistor is heated when an electric current is supplied to the PTC thermistor. When the PTC thermistor is heated, the temperature T and the resistance R of the PTC thermistor vary according to the function represented in FIG. 1.

In particular, the PTC thermistor may be heated to a temperature TMR which corresponds to a minimum resistance MR of the PTC thermistor.

When the PTC thermistor is heated to temperatures T below the temperature corresponding to the minimum resistance TMR, the resistance R of the PTC thermistor slightly decreases when the temperature T of the PTC thermistor increases, according to the function of FIG. 1. In some PTC thermistors, the resistance R of the PTC thermistor remains substantially constant, at a resistance slightly above the minimum resistance MR of the PTC thermistor, until the minimum resistance MR of the PTC thermistor is reached at the temperature corresponding to the minimum resistance TMR.

Likewise, if the PTC thermistor is heated to a temperature T beyond the temperature corresponding to the minimum resistance TMR, the resistance R of the PTC thermistor increases when the temperature T of the PTC thermistor increases, according to the function of FIG. 1.

If the PTC thermistor is heated to a temperature beyond the temperature corresponding to twice the minimum resistance TMR, the increase in the resistance of the PTC thermistor when the temperature of the PTC thermistor increases is so significant that the temperature of the PTC thermistor is substantially stabilised at the temperature T corresponding to twice the minimum resistance MR. Such temperature is normally referred to as reference temperature CT of the PTC thermistor. Put another way, the PTC thermistor has a high positive temperature coefficient α within a stabilised temperature range delimited at the lower end by the reference temperature CT. In dielectric materials, the reference temperature CT may substantially correspond to the Curie temperature of the dielectric material.

Temperatures T substantially beyond the reference temperature CT may be reached if the PTC thermistor is supplied with electric current for a period of time long enough to reach the maximum resistance of the PTC thermistor. However, it should be taken into account that FIG. 1 shows the resistance R in a logarithmic scale. Hence, the period of time needed to reach such maximum resistance is generally substantially longer than a conventional operating time of the heater for heating an aerosol-forming substrate. This may ensure that the PTC thermistor is effectively stabilised at a temperature which does not significantly exceed the reference temperature CT.

FIG. 2 illustrates a heater 10 comprising a heater housing 20. The heater housing 20 comprises a peripheral portion 21 extending in the transversal direction between a peripheral inner wall 210 and a peripheral outer wall 211. The heater housing 20 comprises a bottom portion 22 extending in the longitudinal direction between a bottom inner wall 220 and a bottom outer wall 221. A cavity 23 for receiving the aerosol-forming substrate extends longitudinally between an open end 230 of the heater housing 20 and the bottom inner wall 220, the cavity 23 being delimited in the transversal direction by the peripheral inner wall 210. In the embodiment of FIG. 2, the heater comprises a heating element which is formed of a PTC disk 24 arranged within the bottom portion 22. When an electric current is supplied to the PTC disk 24, the temperature of the PTC disk 24 increases until it reaches the reference temperature of the PTC disk 24. If the supply of electric current is maintained after this instant, the temperature of the PTC disk 24 stabilises at a temperature which substantially corresponds to the reference temperature of the PTC disk 24. Thus, the peripheral inner wall 210 reaches a temperature that may not significantly differ from the temperature at which the PTC disk 24 stabilises. Hence, when the aerosol-forming substrate is received in the cavity 23, the aerosol-forming substrate may be heated to the temperature of the peripheral inner wall 210, such that an inhalable aerosol is formed.

FIG. 3 illustrates a heater 10 comprising a heater housing 20. The heater housing 20 comprises a peripheral portion 21 extending in the transversal direction between a peripheral inner wall 210 and a peripheral outer wall 211. The heater housing 20 comprises a bottom portion 22 extending in the longitudinal direction between a bottom inner wall 220 and a bottom outer wall 221. A cavity 23 for receiving the aerosol-forming substrate extends longitudinally between an open end 230 of the heater housing 20 and the bottom inner wall 220, the cavity 23 being delimited in the transversal direction by the peripheral inner wall 210. In the embodiment of FIG. 3, the heater comprises a heating element which is formed of a PTC tube 25 arranged within the peripheral portion 21. When an electric current is supplied to the PTC tube 25, the temperature of the PTC tube 25 increases until it reaches the reference temperature of the PTC tube 25. If the supply of electric current is maintained after this instant, the temperature of the PTC tube 25 stabilises at a temperature which substantially corresponds to the reference temperature of the PTC tube 25. Thus, the peripheral inner wall 210 reaches a temperature which substantially corresponds to the reference temperature of the PTC tube 25. Hence, when the aerosol-forming substrate is received in the cavity 23, the aerosol-forming substrate may be heated to the temperature which substantially corresponds to the reference temperature of the PTC tube 25, such that an inhalable aerosol is formed.

FIG. 4 illustrates a heater 10 comprising a heater housing 20. The heater housing 20 comprises a peripheral portion 21 extending in the transversal direction between a peripheral inner wall 210 and a peripheral outer wall 211. The heater housing 20 comprises a bottom portion 22 extending in the longitudinal direction between a bottom inner wall 220 and a bottom outer wall 221. A cavity 23 for receiving the aerosol-forming substrate extends longitudinally between an open end 230 of the heater housing 20 and the bottom inner wall 220, the cavity 23 being delimited in the transversal direction by the peripheral inner wall 210. In the embodiment of FIG. 4, the heater comprises a heating element which is formed of a PTC blade 27 extending longitudinally within the cavity 23, so that the PTC blade 27 is configured to pierce the aerosol-forming substrate when the substrate is received in the cavity 23. When electric current is supplied to the PTC blade 27, the temperature of the PTC blade 27 increases until it reaches the reference temperature of the PTC blade 27. If the supply of electric current is maintained after this instant, the temperature of the PTC blade 27 stabilises at a temperature which substantially corresponds to the reference temperature of the PTC blade 27. Thus, the PTC blade 27 may be used to heat the aerosol-forming substrate at substantially the reference temperature of the PTC blade, such that an inhalable aerosol is formed.

FIG. 5 depicts a perspective view of a heater housing 20. The heater housing 20 comprises a peripheral portion 21 extending in the transversal direction between a peripheral inner wall 210 and a peripheral outer wall 211. The peripheral outer wall 211 comprises six planar sections 2110, 2111, 2112, 2113, 2114, 2115, configured such that at least one PTC plate can be arranged on at least one planar section 2110, 2111, 2112, 2113, 2114, 2115. The PCT plate may be a round plate, square plate or a polygonal plate. The plates are planar. FIG. 6 is a representation of a cross section of the heater housing 20 of FIG. 5. A cavity 23 for receiving the aerosol-forming substrate extends longitudinally between an open end 230 and the bottom inner wall 220 (not represented in FIGS. 5 and 6), the cavity 23 being delimited in the transversal direction by the peripheral inner wall 210. In the embodiment of FIGS. 5 and 6, the cavity 23 delimited by the peripheral inner wall 210 is cylindrical, that is, the peripheral inner wall 23 has a circular cross section, as is shown in FIG. 5. Such shape may be convenient to receive a cylindrical aerosol-forming substrate.

In a preferred embodiment, the heater housing 20 of FIGS. 5 and 6 is provided with six PTC plates, one on each planar section 2110, 2111, 2112, 2113, 2114, 2115, thus forming a heater 10.

In an embodiment, the heater housing 20 comprises an electrically conductive material, such as an electrically conductive metal. The heater housing 20 then forms a first electrode configured to be in electrical contact with the six PTC plates.

The heater 10 may also comprise at least one external electrical contact 30 comprising an electrically conductive material, such as an electrically conductive metal, and forming a second electrode configured to be in electrical contact with the six PTC plates. FIG. 7 depicts the at least one external electrical contact 30 comprising six elongate external electrical contacts 310, 311, 312, 313, 314, 315, each one configured to be in electrical contact with a PTC plate disposed on a planar section 2110, 2111, 2112, 2113, 2114, 2115.

FIG. 8 illustrates the heater 10 comprising the heater housing 20 of FIGS. 5 and 6 and the elongate external electrical contacts 310, 311, 312, 313, 314, 315 of FIG. 7. Six PTC plates 260, 261, 262, 263, 264, 265 are provided, one on each planar section 2110, 2111, 2112, 2113, 2114, 2115. The six PTC plates 260, 261, 262, 263, 264, 265 form the heating element of the heater 10. The heater housing 20 acts as first electrode for the PTC plates 260, 261, 262, 263, 264, 265, since the PTC plates 260, 261, 262, 263, 264, 265 are in electrical contact with the planar sections 2110, 2111, 2112, 2113, 2114, 2115 of the heater housing 20. The elongate external electrical contacts 310, 311, 312, 313, 314, 315, which are in electrical contact with the PTC plates 260, 261, 262, 263, 264, 265, act as a second electrode for the PTC plates 260, 261, 262, 263, 264, 265.

When electric current is supplied to the first and second electrodes, the temperature of the PTC plates 260, 261, 262, 263, 264, 265 increases until the reference temperature of the PTC plates 260, 261, 262, 263, 264, 265 is reached, as shown in FIG. 1. After such instant, the temperature of the PTC plates 260, 261, 262, 263, 264, 265 stabilises substantially at the reference temperature of the PTC plates 260, 261, 262, 263, 264, 265 (or at a temperature slightly above the reference temperature) for periods of time that are normally longer than the operating time of an aerosol-generating device. This allows for a consistent and predictable heating profile of the aerosol-forming substrate when the substrate is received in the cavity 23, in which the maximum temperature of each of the PTC plates 260, 261, 262, 263, 264, 265 during the operating time can be determined and controlled by selecting the reference temperature of the PTC plates 260, 261, 262, 263, 264, 265. The PTC plates 260, 261, 262, 263, 264, 265 may have the same or a different reference temperature.

FIG. 9 represents the temperature of the peripheral inner wall 210 for four examples of the heater 10 of FIG. 8 in which the reference temperature of the six PTC plates 260, 261, 262, 263, 264, 265 is identical.

In the first example CT190, the reference temperature of the six PTC plates 260, 261, 262, 263, 264, 265 is 190 degrees Celsius. When an electric current is supplied to the first and second electrodes, the six PTC plates 260, 261, 262, 263, 264, 265 reach their reference temperature of 190 degrees Celsius after approximately 30 seconds and stabilise at a temperature slightly above the reference temperature. Heat is transferred through the heater housing 20 in such a way that the temperature of the inner wall 210 is substantially the same as the temperature of the six PTC plates 260, 261, 262, 263, 264, 265, that is, slightly above 190 degrees Celsius, as shown in FIG. 9. When an aerosol-forming substrate is received in the cavity 23 after the inner wall 210 has reached the temperature of substantially 190 degrees Celsius, this temperature is consistently applied to the aerosol-forming substrate during the operating time of the heater 10, thus forming an inhalable aerosol.

In the second example CT200, the reference temperature of the six PTC plates 260, 261, 262, 263, 264, 265 is 200 degrees Celsius. When an electric current is supplied to the first and second electrodes, the six PTC plates 260, 261, 262, 263, 264, 265 reach their reference temperature of 200 degrees Celsius after approximately 30 seconds and stabilise at a temperature slightly above the reference temperature. Heat is transferred through the heater housing 20 in such a way that the temperature of the inner wall 210 is substantially the same as the temperature of the six PTC plates 260, 261, 262, 263, 264, 265, that is, slightly above 200 degrees Celsius, as shown in FIG. 9. When an aerosol-forming substrate is received in the cavity 23 after the inner wall 210 has reached the temperature of substantially 200 degrees Celsius, this temperature is consistently applied to the aerosol-forming substrate during the operating time of the heater 10, thus forming an inhalable aerosol.

In the third example CT210, the reference temperature of the six PTC plates 260, 261, 262, 263, 264, 265 is 210 degrees Celsius. When an electric current is supplied to the first and second electrodes, the six PTC plates 260, 261, 262, 263, 264, 265 reach their reference temperature of 210 degrees Celsius after approximately 30 seconds and stabilise at a temperature slightly above the reference temperature. Heat is transferred through the heater housing 20 in such a way that the temperature of the inner wall 210 is substantially the same as the temperature of the six PTC plates 260, 261, 262, 263, 264, 265, that is, slightly above 210 degrees Celsius, as shown in FIG. 9. When an aerosol-forming substrate is received in the cavity 23 after the inner wall 210 has reached the temperature of substantially 210 degrees Celsius, this temperature is consistently applied to the aerosol-forming substrate during the operating time of the heater 10, thus forming an inhalable aerosol.

In the fourth example CT220, the reference temperature of the six PTC plates 260, 261, 262, 263, 264, 265 is 220 degrees Celsius. When an electric current is supplied to the first and second electrodes, the six PTC plates 260, 261, 262, 263, 264, 265 reach their reference temperature of 220 degrees Celsius after approximately 30 seconds and stabilise at a temperature slightly above the reference temperature. Heat is transferred through the heater housing 20 in such a way that the temperature of the inner wall 210 is substantially the same as the temperature of the six PTC plates 260, 261, 262, 263, 264, 265, that is, slightly above 220 degrees Celsius, as shown in FIG. 9. When an aerosol-forming substrate is received in the cavity 23 after the inner wall 210 has reached the temperature of substantially 220 degrees Celsius, this temperature is consistently applied to the aerosol-forming substrate during the operating time of the heater 10, thus forming an inhalable aerosol.

FIGS. 10 and 11 show schematic cross-sections of an aerosol-generating device 200 and an aerosol-generating article 300. The aerosol-generating device 200 and the aerosol-generating article 300 form an aerosol-generating system.

The aerosol-generating device 200 comprises a substantially cylindrical device housing 202, with a shape and size similar to a conventional cigar.

The aerosol-generating device 200 further comprises a power supply 206, in the form of a rechargeable nickel-cadmium battery, a PCB (printed circuit board) controller 208 including a microprocessor and a memory, an electrical connector 209 and a heater 10. In the embodiment of FIGS. 10 and 11, the heater 10 is similar to that of FIG. 3. However, other heaters may be used. In particular, the heaters of FIGS. 2, 4 and 8 may be used.

The power supply 206, controller 208 and heater 10 are all housed within the device housing 202. The heater 10 of the aerosol-generating device 200 is arranged at the proximal end of the device 200. The electrical connector 209 is arranged at a distal end of the device housing 202.

As used herein, the term “proximal” refers to a user end, or mouth end of the aerosol-generating device or aerosol-generating article, that is, the end of the aerosol-generating device or aerosol-generating article configured to be the closest to the user's mouth during normal use of the aerosol-generating device or aerosol-generating system comprising the aerosol-generating device and the aerosol-generating article. The proximal end of a component of an aerosol-generating device or an aerosol-generating article is the end of the component the closest to the user end, or mouth end of the aerosol-generating device or the aerosol-generating article. As used herein, the term “distal” refers to the end opposite the proximal end.

The controller 208 is configured to control the supply of power from the power supply 206 to the heater 10. The controller 208 further comprises a DC/AC inverter, including a Class-D power amplifier. The controller 208 is also configured to control recharging of the power supply 206 from the electrical connector 209. The controller 208 further comprises a puff sensor (not shown) configured to sense when a user is drawing on an aerosol-generating article received in the cavity 23.

As explained for FIG. 3, the heater 10 comprises a heater housing 20. The heater housing 20 comprises a peripheral portion 21 extending in the transversal direction between a peripheral inner wall 210 and a peripheral outer wall 211. The heater housing 20 comprises a bottom portion 22 extending in the longitudinal direction between a bottom inner wall 220 and a bottom outer wall 221. A cavity 23 for receiving the aerosol-forming substrate extends longitudinally between an open end 230 and the bottom inner wall 220, the cavity 23 being delimited in the transversal direction by the peripheral inner wall 210. A PTC tube 25 is arranged within the peripheral portion 21 so as to circumscribe the peripheral inner wall 210.

The device housing 202 also defines an air inlet 280 in close proximity to the distal end of the cavity 23 for receiving the aerosol-forming substrate. The air inlet 280 is configured to enable ambient air to be drawn into the device housing 202. Airflow pathways (not represented) are defined through the device 200 to enable air to be drawn from the air inlet 280 into the cavity 23.

The aerosol-generating article 300 is generally in the form of a cylindrical rod, having a diameter similar to the diameter of the peripheral inner wall 210. The aerosol-generating article 300 comprises a cylindrical cellulose acetate filter plug 304 and a cylindrical aerosol-generating segment 310 wrapped together by an outer wrapper 320 of cigarette paper.

The filter plug 304 is arranged at a proximal end of the aerosol-generating article 300, and forms the mouthpiece of the aerosol-generating system, on which a user draws to receive aerosol generated by the system.

The aerosol-generating segment 310 is arranged at a distal end of the aerosol-generating article 300, and has a length substantially equal to the length of the cavity 23. Although the aerosol-generating segment 310 of FIGS. 10 and 11 comprises only one aerosol-forming substrate, the aerosol-generating segment may equally include several aerosol-forming substrates. When there are multiple aerosol-forming substrates, the substrates may be arranged end-to-end with respect to one another in the longitudinal direction of the aerosol-generating article 300. However, it is envisaged that in other embodiments, a separation may be provided between the aerosol-forming substrates. It will be appreciated that in some embodiments two or more of the aerosol-forming substrates may be formed from the same materials, whereas in other embodiments, each of the aerosol-forming substrates is different. For example, one or more of the aerosol-forming substrates may comprise a gathered and crimped sheet of homogenised tobacco material including a flavouring in the form of menthol. One or more of the aerosol-forming substrates may also comprise a flavouring in the form of menthol, and not comprise tobacco material or any other source of nicotine. The one or more aerosol-forming substrates may also comprise further components, such as one or more aerosol formers and water, such that heating the aerosol-forming substrate generates an aerosol with desirable organoleptic properties.

The proximal end of the aerosol-generating segment 310 is exposed, as it is not covered by an outer wrapper 320. When the aerosol-generating segment 310 comprises several aerosol-forming substrates, the outer wrapper 320 may comprise a line of perforations circumscribing the aerosol-generating article 300 at the interface between the aerosol-forming substrates. The perforations enable air to be drawn into the aerosol-generating segment 310.

FIG. 12 shows an aerosol-generating article 300 similar to those of FIGS. 10 and 11. However, the filter plug 304 is a filter assembly 304 in the form of a rod. The filter assembly 304 includes three segments: a cooling segment 307, a filter segment 309 and a mouth end segment 311. In the embodiment of FIG. 12, the cooling segment 307 is located between the second aerosol-generating segment 310 and the filter segment 309, such that the cooling segment 307 is in an abutting relationship with the aerosol-generating segment 310 and the filter segment 309. In other examples, there may be a separation between aerosol-generating segment 310 and the cooling segment 307 and between the cooling segment 307 and the filter segment 309. The filter segment 309 is located in between the cooling segment 307 and the mouth end segment 311. The mouth end segment 311 is located towards the proximal end of the article 300, adjacent the filter segment 309. In the embodiment of FIG. 12, the filter segment 309 is in an abutting relationship with the mouth end segment 311. In one example, the total length of the filter assembly 304 is between 37 millimetres and 45 millimetres, more preferably, the total length of the filter assembly 304 is 41 millimetres.

In one example of the embodiment of FIG. 12, the aerosol-generating segment 310 is between 34 millimetres and 50 millimetres in length, more preferably, the aerosol-generating segment 310 is between 38 millimetres and 46 millimetres in length, more preferably still, the aerosol-generating segment 310 is 42 millimetres in length.

In one example of the embodiment of FIG. 12, the total length of the article 300 is between 71 millimetres and 95 millimetres, more preferably, the total length of the article 300 is between 79 millimetres and 87 millimetres, more preferably still, the total length of the article 300 is 83 millimetres.

In one example, the cooling segment 307 is an annular tube and defines an air gap within the cooling segment 307. The air gap provides a chamber for heated volatilised components generated from the aerosol-generating segment 310 to flow. The cooling segment 307 is hollow to provide a chamber for aerosol accumulation yet rigid enough to withstand axial compressive forces and bending moments that might arise during manufacture and whilst the article 300 is in use during insertion into the aerosol-generating device 200. In one example, the thickness of the wall of the cooling segment 307 is approximately 0.29 millimetres.

The cooling segment 307 provides a physical displacement between the aerosol-generating segment 310 and the filter segment 309. The physical displacement provided by the cooling segment 307 will provide a thermal gradient across the length of the cooling segment 307. In one example the cooling segment 307 is configured to provide a temperature differential of at least 40 degrees Celsius between a heated volatilised component entering a distal end of the cooling segment 307 and a heated volatilised component exiting a proximal end of the cooling segment 307. In one example, the cooling segment 307 is configured to provide a temperature differential of at least 60 degrees Celsius between a heated volatilised component entering a distal end of the cooling segment 307 and a heated volatilised component exiting a proximal end of the cooling segment 307. This temperature differential across the length of the cooling segment 307 protects the temperature sensitive filter segment 309 from the high temperatures of the aerosol formed from the aerosol-generating segment 310.

In one example of the article 300 of FIG. 12, the length of the cooling segment 307 is at least 15 millimetres. In one example, the length of the cooling segment 307 is between 20 millimetres and 30 millimetres, more particularly 23 millimetres to 27 millimetres, more particularly 25 millimetres to 27 millimetres and more particularly 25 millimetres.

The cooling segment 307 is made of paper, which means that it is comprised of a material that does not generate compounds of concern. In one example of the article 300 of FIG. 12, the cooling segment 307 is manufactured from a spirally wound paper tube which provides a hollow internal chamber yet maintains mechanical rigidity. Spirally wound paper tubes are able to meet the tight dimensional accuracy requirements of high-speed manufacturing processes with respect to tube length, outer diameter, roundness and straightness. In another example, the cooling segment 307 is a recess created from stiff plug wrap or tipping paper. The stiff plug wrap or tipping paper is manufactured to have a rigidity that is sufficient to withstand the axial compressive forces and bending moments that might arise during manufacture and whilst the article 300 is in use during insertion into the aerosol-generating device 200.

For each of the examples of the cooling segment 307, the dimensional accuracy of the cooling segment is sufficient to meet the dimensional accuracy requirements of high-speed manufacturing process.

The filter segment 309 may be formed of any filter material sufficient to remove one or more volatilised compounds from heated volatilised components from the aerosol-generating segment 310. In one example of the article 300 of FIG. 12, the filter segment 309 is made of a mono-acetate material, such as cellulose acetate. The filter segment 309 provides cooling and irritation-reduction from the heated volatilised components without depleting the quantity of the heated volatilised components to an unsatisfactory level for a user.

The density of the cellulose acetate tow material of the filter segment 309 controls the pressure drop across the filter segment 309, which in turn controls the draw resistance of the article 300. Therefore the selection of the material of the filter segment 309 is important in controlling the resistance to draw of the article 300. In addition, the filter segment performs a filtration function in the article 300.

The presence of the filter segment 309 provides an insulating effect by providing further cooling to the heated volatilised components that exit the cooling segment 307. This further cooling effect reduces the contact temperature of the user's lips on the surface of the filter segment 309.

One or more flavours may be added to the filter segment 309 in the form of either direct injection of flavoured liquids into the filter segment 309 or by embedding or arranging one or more flavoured breakable capsules or other flavour carriers within the cellulose acetate tow of the filter segment 309. In one example of the article 300 of FIG. 12, the filter segment 309 is between 6 millimetres to 10 millimetres in length, more preferably 8 millimetres.

The mouth end segment 311 is an annular tube and defines an air gap within the mouth end segment 311. The air gap provides a chamber for heated volatilised components that flow from the filter segment 309. The mouth end segment 311 is hollow to provide a chamber for aerosol accumulation yet rigid enough to withstand axial compressive forces and bending moments that might arise during manufacture and whilst the article is in use during insertion into the aerosol-generating device 200. In one example, the thickness of the wall of the mouth end segment 311 is approximately 0.29 millimetres.

In one example, the length of the mouth end segment 311 is between 6 millimetres to 10 millimetres and more preferably 8 millimetres.

The mouth end segment 311 may be manufactured from a spirally wound paper tube which provides a hollow internal chamber yet maintains critical mechanical rigidity. Spirally wound paper tubes are able to meet the tight dimensional accuracy requirements of high-speed manufacturing processes with respect to tube length, outer diameter, roundness and straightness.

The mouth end segment 311 provides the function of preventing any liquid condensate that accumulates at the exit of the filter segment 309 from coming into direct contact with a user.

It should be appreciated that, in one example, the mouth end segment 311 and the cooling segment 307 may be formed of a single tube and the filter segment 309 is located within that tube separating the mouth end segment 311 and the cooling segment 307.

In the article 300 of FIG. 12, ventilation holes 317 are located in the cooling segment 307 to aid with the cooling of the article 300. In one example, the ventilation holes 317 comprise one or more rows of holes, and preferably, each row of holes is arranged circumferentially around the article 300 in a cross-section that is substantially perpendicular to a longitudinal axis of the article 300.

In one example of the article 300 of FIG. 12, there are between one to four rows of ventilation holes 317 to provide ventilation for the article 300. Each row of ventilation holes 317 may have between 12 to 36 ventilation holes 317. The ventilation holes 317 may, for example, be between 100 to 500 micrometres in diameter. In one example, an axial separation between rows of ventilation holes 317 is between 0.25 millimetres and 0.75 millimetres, more preferably, an axial separation between rows of ventilation holes 317 is 0.5 millimetres.

In one example of the article 300 of FIG. 12, the ventilation holes 317 are of uniform size. In another example, the ventilation holes 317 vary in size. The ventilation holes 317 can be made using any suitable technique, for example, one or more of the following techniques: laser technology, mechanical perforation of the cooling segment 307 or pre-perforation of the cooling segment 307 before it is formed into the article 300. The ventilation holes 317 are positioned so as to provide effective cooling to the article 300.

In one example of the article 300 of FIG. 12, the rows of ventilation holes 317 are located at least 11 millimetres from the proximal end of the article 300, more preferably the ventilation holes 317 are located between 17 millimetres and 20 millimetres from the proximal end of the article 300. The location of the ventilation holes 317 is positioned such that user does not block the ventilation holes 317 when the article 300 is in use.

Advantageously, providing the rows of ventilation holes between 17 millimetres and 20 millimetres from the proximal end of the article 300 enables the ventilation holes 317 to be located outside of the aerosol-generating device 200 when the article 300 is fully inserted in the aerosol-generating device 200. By locating the ventilation holes 317 outside of the device 200, non-heated air is able to enter the article 300 through the ventilation holes from outside the device 200 to aid with the cooling of the article 300.

The length of the cooling segment 307 is such that the cooling segment 307 will be partially inserted into the device 200 when the article 300 is fully inserted into the device 200.

In use, when an aerosol-generating article 300 is received in the cavity 23, a user may draw on the proximal end of the aerosol-generating article 300 to inhale aerosol generated by the aerosol-generating system. When a user draws on the proximal end of the aerosol-generating article 300, air is drawn into the device housing 202 at the air inlet 280, and is drawn into the aerosol-generating segment 310 of the aerosol-generating article 300.

In the embodiment of FIGS. 11 and 12, the controller 208 of the aerosol-generating device 200 is configured to supply electric current to the PTC tube 25 arranged within the peripheral portion 21 of the heater housing 20. The temperature of the PTC tube 25 increases until it reaches the reference temperature of the PTC tube 25. After such instant, the temperature of the PTC tube 25 stabilises at a temperature substantially equal to the reference temperature of the PTC tube 25 for a period of time that generally exceeds a user's session time for the aerosol-generating device 200. The heating profile of the aerosol-forming substrate contained in the aerosol-generating segment 310 of the aerosol-generating article 300 received in the cavity 23 can therefore be determined in function of the reference temperature of the PTC tube 25.

In the heater of FIGS. 3 and 10, the temperature of the PTC tube TE is substantially the same as the temperature of the peripheral inner wall TI, that is, substantially the same as the temperature that will be applied to the aerosol-forming substrate. This is represented in the graphic of FIG. 13. The reference temperature of the PTC tube 25 of the heater 10 of FIG. 13 is 200 degrees Celsius, which substantially corresponds to the temperature of the PTC tube TE and to the temperature of the peripheral inner wall TI after the stabilisation time.

In the case of the heater of FIG. 8, the temperature of the six PTC plates TE does also substantially corresponds to the temperature of the peripheral inner wall TI. However, differently to the case of FIG. 12, the stabilisation time may be inferior. In particular, the temperature of the six PTC plates TE and the temperature of the peripheral inner wall TI may stabilise at substantially the reference temperature of the six PTC plates at 30 seconds.

FIG. 14 represents the evolution of the temperature of the PTC disk TE and the temperature of the peripheral inner wall TI with time for the heater 10 of FIG. 2. In this embodiment, it can be appreciated that the temperature of the peripheral inner wall TI is lower than the temperature of the PTC disk TE. In particular, for a PTC disk 24 with a reference temperature of 220 degrees Celsius, the temperature of peripheral inner wall TI stabilises at 210.

FIG. 15 shows a temperature T/resistance R graphic of a PTC thermistor comprised in a heating element of a heater for heating an aerosol-forming substrate when different constant voltages V are supplied to the PTC thermistor. In FIG. 15, a first voltage V1 is greater than a second voltage V2, which is in turn greater than a third voltage V3. As can be appreciated in FIG. 15, the reference temperature CT of the PTC thermistor is dependent on the voltage V applied to the PTC thermistor. In particular, the first voltage V1 leads to a first reference temperature CT1, the second voltage V2 leads to a second reference temperature CT2 and the third voltage V3 leads to a third reference temperature CT3, such that the first reference temperature CT1 is greater than the second reference temperature CT2, which in turn is greater than the third reference temperature CT3.

A controller may control a power supply to supply an electric current to the PTC thermistor having the first voltage V1, the second voltage V2, the third voltage V3 or any other suitable voltage. The reference temperature of the PTC thermistor will therefore be adjusted to the first reference temperature CT1, the second reference temperature CT2, the third reference temperature CT3 or any other suitable temperature. The relationship between the supplied voltage V and the reference temperature CT for a particular PTC thermistor may be stored in the controller; in a preferred embodiment, such relationship may be stored in a memory comprised in the controller. Likewise, the first reference temperature CT1, the second reference temperature CT2, the third reference temperature CT3 or any other suitable temperature may be determined to correspond to the desired maximum operating temperatures for one or more aerosol-forming substrates. The controller may also store one or more maximum operating temperatures for a given aerosol-forming substrate; in a preferred embodiment, such maximum operating temperatures may be stored in a memory comprised in the controller.

The PTC thermistor of the aerosol-generating system may thus substantially stabilise at the maximum operating temperature which is determined by the controller for a given aerosol-forming substrate. The temperatures at which the PTC thermistor stabilises is substantially the same as, or sufficiently close to, the temperature applied to the aerosol-forming substrate when the aerosol-generating system is in use to heat the aerosol-forming substrate, as explained for the heaters of the above embodiments. Therefore, the temperatures at which the PTC thermistor stabilises may be chosen to optimise the formation of aerosol. This may be beneficial to provide an optimised aerosol experience.

1.-15. (canceled)

16. A heater for heating an aerosol-forming substrate, the heater comprising:
a heating element configured to heat the aerosol-forming substrate, the heating element comprising at least one positive temperature coefficient (PTC) thermistor, the at least one PTC thermistor being configured to be supplied with an electric current so as to heat the at least one PTC thermistor,
wherein a resistance of the at least one PTC thermistor increases when a temperature of the at least one PTC thermistor increases within a stabilised temperature range, a lower end of the stabilised temperature range being, when a constant voltage is applied to the at least one PTC thermistor, a reference temperature at which the resistance of the at least one PTC thermistor is twice a value of a minimum resistance of the at least one PTC thermistor, and
wherein the reference temperature is between about 100 degrees Celsius and about 350 degrees Celsius when a constant voltage of 3.3 Volts is applied to the at least one PTC thermistor.

17. The heater according to claim 16, wherein the reference temperature is between about 200 degrees Celsius and about 250 degrees Celsius when a constant voltage of 3.3 Volts is applied to the at least one PTC thermistor.

18. The heater according to claim 16, wherein the heating element is further configured to be inserted into the aerosol-forming substrate.

19. The heater according to claim 16, wherein the heating element is further configured to heat an outer surface of the aerosol-forming substrate.

20. The heater according to claim 16,
further comprising a cavity configured to receive the aerosol-forming substrate,
wherein the heater is further configured to heat the aerosol-forming substrate when the aerosol-forming substrate is received in the cavity.

21. The heater according to claim 20,
further comprising a heater housing, the heater housing comprising a peripheral portion extending in a transversal direction between a peripheral inner wall and a peripheral outer wall, and a bottom portion extending in a longitudinal direction between a bottom inner wall and a bottom outer wall,
wherein the cavity extends longitudinally between an open end and the bottom inner wall, the cavity being delimited in the transversal direction by the peripheral inner wall.

22. The heater according to claim 21, wherein the at least one PTC thermistor comprises a PTC disk arranged within the bottom portion.

23. The heater according to claim 21, wherein the at least one PTC thermistor comprises a PTC tube arranged within the peripheral portion so as to circumscribe the peripheral inner wall.

24. The heater according to claim 21,
wherein the peripheral outer wall comprises at least three planar sections, and
wherein the at least one PTC thermistor comprises at least one PTC plate arranged on at least one of the at least three planar sections.

25. The heater according to claim 16, wherein the at least one PTC thermistor comprises a ceramic semiconductor.

26. The heater according to claim 25, wherein the ceramic semiconductor is barium titanate.

27. The heater according to claim 16, wherein the at least one PTC thermistor comprises a polymeric material.

28. An aerosol-generating device, comprising:
the heater according to claim 16;
a device housing; and
a power supply electrically connected to the heating element to supply an electric current to the at least one PTC thermistor.

29. An aerosol-generating system, comprising:
the aerosol-generating device according to claim 28; and
an aerosol-generating article comprising the aerosol-forming substrate.

30. A method of operating the aerosol-generating system according to claim 29, the method comprising the steps of:
determining a maximum operating temperature for the aerosol-forming substrate comprised in the aerosol-generating article; and
supplying an electric current to the at least one PTC thermistor, by means of the power supply, the electric current having a constant voltage, such that a resistance of the at least one PTC thermistor increases when a temperature of the at least one PTC thermistor increases within a stabilised temperature range, a lower end of the stabilised temperature range being a reference temperature at which the resistance of the at least one PTC thermistor is twice a value of the minimum resistance of the at least one PTC thermistor, the constant voltage being such that the reference temperature of the PTC thermistor is substantially the maximum operating temperature for the aerosol-forming substrate.

31. A method of operating the aerosol-generating system according to claim 29, the method comprising the steps of:
measuring puff intensity when a puff is drawn during use of the aerosol-generating system; and
determining a puff intensity threshold, such that, when the puff intensity is equal to or above the puff intensity threshold, the method further comprises the additional steps of:
determining a first maximum operating temperature and a second maximum operating temperature for the aerosol-forming substrate comprised in the aerosol-generating article,
selecting the first maximum operating temperature or the second maximum operating temperature,
if the first maximum operating temperature is selected, supplying an electric current to the at least one PTC thermistor, by means of the power supply, the electric current having a first constant voltage, such that a resistance of the at least one PTC thermistor increases when a temperature of the at least one PTC thermistor increases within a stabilised temperature range, a lower end of the stabilised temperature range being a reference temperature at which the resistance of the at least one PTC thermistor is twice a value of the minimum resistance of the at least one PTC thermistor, the first constant voltage being such that the reference temperature of the PTC thermistor is substantially the first maximum operating temperature for the aerosol-forming substrate, and
if the second maximum operating temperature is selected, supplying an electric current to the at least one PTC thermistor, by means of the power supply, the electric current having a second constant voltage, such that the resistance of the at least one PTC thermistor increases when the temperature of the at least one PTC thermistor increases within a stabilised temperature range, the lower end of the stabilised temperature range being a reference temperature at which the resistance of the at least one PTC thermistor is twice the value of the minimum resistance of the at least one PTC thermistor, the second constant voltage being such that the reference temperature of the PTC thermistor is substantially the second maximum operating temperature for the aerosol-forming substrate.
